(19) United States
(12) Patent Application Publication
(10) Pub. No.: US 2005/0019630 A1
(43) Pub. Date: Jan. 27, 2005

(54) Fuel cell having a short-circuiting means

(76) Inventor: Dirk Walliser, Aichwald (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/873,638

(22) Filed: Jun. 23, 2004

(30) Foreign Application Priority Data
Jun. 24, 2003 (DE) 103 28 255.6

(51) Int. Cl. H01M 8/04; H01M 8/10

(52) U.S. Cl. 429/24; 429/30

(57) ABSTRACT

In a fuel cell or fuel cell stack, adjacent bipolar plates of a membrane electrode unit have an associated short-circuiting means, which can be activated by the introduction of heat, in order to short-circuit the bipolar plates.

### BACKGROUND AND SUMMARY OF THE INVENTION

This application claims the priority of German patent document 103 28 255.6, filed 24 Jun. 2003, the disclosure of which is expressly incorporated by reference herein.

The invention relates to a fuel cell having at least two bipolar plates separated by a membrane electrode assembly (MEA), which forms at least one contact place, with each bipolar plate and the MEA making indirect or direct electrical contact.

German patent document DE 199 07 369 A1 discloses a fuel cell arrangement in which the fuel cells are connected in parallel with diodes, such that current which is produced by the fuel cell cannot cause a short circuit. If one cell fails, then the current flows via a parallel-connected diode, since the diode then forms a lower resistance. During normal operation, a voltage drop occurs across the diodes, however, and this leads to the introduction of heat.

One object of the present invention is to provide a fuel cell arrangement that ensures simple and effective failure bridging.

This and other objects and advantages are achieved by the fuel cell system according to the invention, in which a short-circuiting means which can be activated by heat is provided in the area between the two adjacent bipolar plates and/or in the two adjacent bipolar plates in order to short circuit the bipolar plates. An increase in the temperature of a defective cell thus causes the short-circuiting means to melt, so that, when it is in the liquid state, it passes through the MEA, assisted by the porosity of the MEA and by the force of gravity. As a result, the two bipolar plates are electrically short-circuited. The polymer electrolyte membrane (PEM) which is arranged within the MEA can in this case be destroyed just by the process of overheating the fuel cell, so that the short-circuiting means can also pass through it. However, it is also possible for the short-circuiting means to melt through the polymer electrolyte membrane (PEM) when in the heated, liquid form, and thus to generate the electrical contact between the two bipolar plates. If one or more fuel cells fail, individual cells allow continued operation of the entire fuel cell stack. While the power of the fuel cell stack is reduced, it remains serviceable, ensuring an emergency operation function for a fuel cell drive. Furthermore, the monitoring complexity and the individual cell voltage monitoring complexity can be restricted, since all that need be expected after a failure of fuel cells is a drop in power.

For this purpose, it is advantageous for the bipolar plate and the MEA to form at least one common contact place or area, and for the short-circuiting means to be provided in the area of the contact place on and/or within the respective bipolar plate. The gas contact with the MEA is maintained by the arrangement of the short-circuiting means in the area of the contact point between the bipolar plate and the MEA.

In one embodiment of the invention, the short-circuiting means is arranged between at least one bipolar plate and the MEA. In this manner, the short-circuiting means can be integrated as a separate component in the design of the fuel cell, or may be connected flat both to the MEA and to the respective bipolar plate. Placement of the short-circuiting means between the bipolar plate and the MEA ensures the contact point and electrical conductivity between the bipolar plate and the MEA.

A further advantage of the invention is that the short-circuiting means is integrated in the respective bipolar plate or in the MEA; or it is fitted to the respective bipolar plate or to the MEA. The integrating of the short-circuiting means in the bipolar plate requires the bipolar plate to have a vessel/pore structure, so that the short-circuiting means can be incorporated. In addition, groove and channel structures are also possible within the surface of the respective bipolar plate.

For this purpose, it is also advantageous for the short-circuiting means to be fusible, with a melting point between 50° C. and 120° C., or preferably between 80° C. and 90° C. The melting temperature or the melting point is in this case matched to the critical temperature point of the fuel cell. Depending on the type of polymer electrolyte membrane (PEM) that is used, the melting point to be used can be matched to the critical temperature of this membrane.

Finally, one preferred embodiment of the invention provides for each bipolar plate and/or the MEA to have a channel and/or pore structure which ensures that the melted short-circuiting means flows. A channel or pore structure that is designed for this purpose allows the short-circuiting means to flow from one bipolar plate to the other. A channel structure is advantageous in order to provide gravity assistance for the flow of the melt, and to deflect optimally and guide the flow of the melt, particularly with respect to the polymer electrolyte membrane (PEM) that is intended to be melted through or destroyed. However, if the melt is also intended to flow upwards against gravity, then a pore structure, with the capillary force associated with it, should be used.

It is particularly important for the present invention, that the short-circuiting means make contact with both bipolar plates, irrespective of the temperature, be electrically conductive in a temperature range between 50° C. and 120° C. (particularly between 80° C. and 90° C.), and be electrically isolating in other temperature ranges. The short-circuiting means is in this case passed through the polymer electrolyte membrane (PEM), and ensures that the two gas areas are separated. At the appropriate temperature, the short-circuiting means becomes electrically conductive, and the fuel cell is short-circuited. The current which flows through the short-circuiting means assists the process of heating it up.

The polymer electrolyte membrane (PEM) is gas-tight when in its undestroyed, operational condition; and is destroyed only in the event of failure of the fuel cell, due to the resulting temperature increase, either from the high temperatures or else by the melting or molten contact means, such that the contact means can electrically connect the two bipolar plates.

In conjunction with the design and arrangement according to the invention, it is advantageous for the short-circuiting means to be able to melt through the polymer electrolyte membrane (PEM). The hot or molten short-circuiting means comes into contact with the polymer electrolyte membrane (PEM) and melts it, thus making an electrical contact or producing a short-circuit between the two bipolar plates, through the polymer electrolyte membrane (PEM).

According to one embodiment of the invention, two or more fuel cells form a fuel cell stack with a gas inlet channel, with the fuel cells or fuel cell parts which are arranged in the area of the gas inlet channel having the short-circuiting means. The MEA may dry out in the area of the gas inlet channel of the fuel cell or of the fuel cell stack, which leads in turn to failure of the fuel cell or of that part of the stack. The use of the short-circuiting means, particularly in this endangered area of the fuel cell stack, allows the fuel cells to continue to operate, albeit at reduced power.

In another embodiment of the invention, two or more fuel cells form a fuel cell stack, with the fuel cells or fuel cell parts which are arranged in an area of the fuel cell stack where the temperature is critical having the short-circuiting means. Those parts of the fuel cell stack, the fuel cells that are arranged there or their parts which are particularly at risk if heated, can be bridged by the use of the short-circuiting means when overheating occurs. This reduces the failure probability of the entire fuel cell stack, with regard to the endangered points within the stack.

Other objects, advantages and novel features of the present invention will become apparent from the following detailed description of the invention when considered in conjunction with the accompanying drawings.

### BRIEF DESCRIPTION OF THE DRAWINGS

FIG. 1 is a cross sectional view of a fuel cell comprising two bipolar plates with an integrated short-circuiting means and a membrane electrode unit (MEA);

FIG. 2 is a cross sectional view of a fuel cell with two bipolar plates, a membrane electrode unit (MEA) and a short-circuiting means;

FIG. 3 is a cross sectional view of a fuel cell with two bipolar plates and a membrane electrode unit (MEA) with an integrated short-circuiting means; and

FIG. 4 is a cross sectional view of a fuel cell with two bipolar plates, a membrane electrode unit (MEA) and a continuously arranged short-circuiting means.

### DETAILED DESCRIPTION OF DRAWINGS

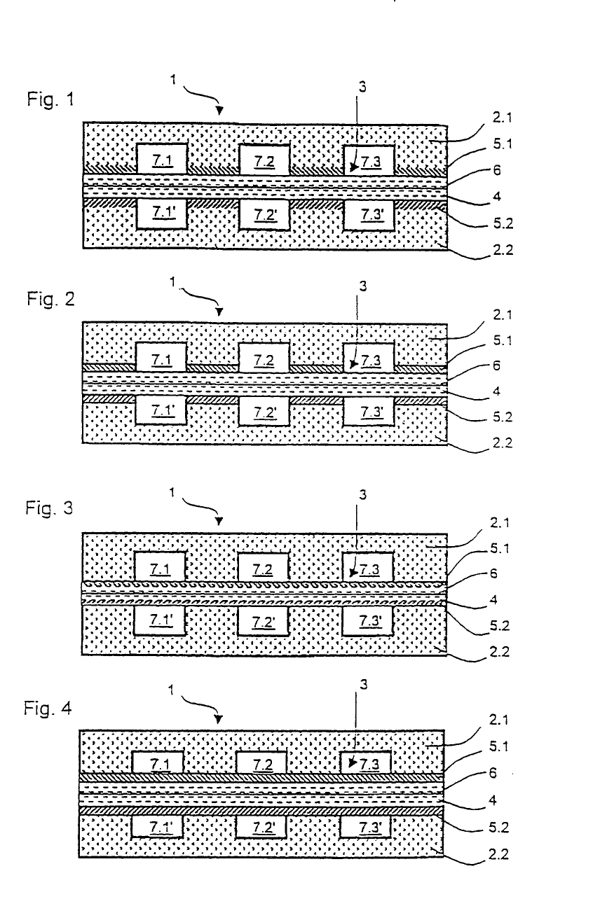

As shown in FIG. 1, the fuel cell 1 comprises an upper (first) bipolar plate 2.1. and a lower (second) bipolar plate 2.2. Each bipolar plate 2.1, 2.2 has recesses 7.1-7.3, 7.1′-7.3′ in the form of grooves, each forming a flow channel.

A membrane electrode unit 4 is arranged between the bipolar plates 2.1, 2.2., and rests flat on the respective bipolar plate 2.1, 2.2, such that the recesses 7.1-7.3, 7.1′-7.3′ are closed to form channels by the membrane electrode unit 4 on their face opposite the base of the groove.

With the membrane electrode unit 4, a polymer electrolyte membrane (PEM) 6 is provided to separate the two bipolar plates 2.1, 2.2 and the gases which flow there.

The bipolar plate 2.1 has a short-circuiting means 5.1 in the area of a contact place 3 with the membrane electrode unit 4. The short-circuiting means 5.1 is in this case arranged within the bipolar plate 2.1, or within pores or chambers in the bipolar plate 2.1, which need not be described any further. The short-circuiting means 5.1 is thus arranged in the area of the contact place 3 between the bipolar plate 2.1 and the membrane electrode unit 4, as well as between each of the flow channels 7.1-7.3. The penetration depth or the height of the contact means is in this case approximately 30% of the depth of the respective flow channel 7.1-7.3 and, in further exemplary embodiments (not illustrated), is designed to correspond to the thickness or height of the membrane electrode unit 4.

The lower, second bipolar plate 2.2 likewise has a short-circuit means 5.2 of the same type and configuration as the first bipolar plate 2.1.

In FIG. 2, the short-circuiting means 5.1, 5.2 is not integrated in the bipolar plate 2.1, 2.2, but is arranged in the area of the respective contact place 3 between the respective bipolar plate 2.1, 2.2 and the membrane electrode unit 4. The short-circuiting means 5.1, 5.2 is thus held like a sandwich between the respective contact place 3 of the respective bipolar plate 2.1, 2.2 and the membrane electrode unit 4.

According to the exemplary embodiment shown in FIG. 3, the short-circuiting means 5.1, 5.2 is integrated within the membrane electrode unit 4. The short-circuiting means 5.1, 5.2 is in this case arranged within pores or recesses (not shown in detail) or channels 7.1-7.3, 7.1′-7.3′ within the membrane electrode unit 4, or in the area of its contact surface. The short-circuit means 5.1, 5.2 thus extends over the entire surface in the area of the surface of the membrane electrode unit 4 having the respective bipolar plate 2.1, 2.2. In exemplary embodiments which are not illustrated, the penetration depth or height of the short-circuit means 5.1, 5.2 is designed to be correspondingly greater than or less than the thickness of the membrane electrode unit 4.

The short-circuiting means 5.1, 5.2 shown in FIG. 4 is once again held like a sandwich between the respective bipolar plate 2.1, 2.2 and the membrane electrode unit 4. The short-circuiting means 5.1, 5.2 in this case extends in a corresponding manner over the entire surface of the membrane electrode unit 4, and thus represents the closure surface of the flow channels 7.1-7.3, 7.1′-7.3′. In exemplary embodiments which are not illustrated in any more detail, the thickness of the short-circuiting means 5.1, 5.2 varies corresponding to the thickness of the membrane electrode unit 4.

The fuel cell according to the invention is in principle suitable for both mobile devices and for stationary devices. However, it is preferably used in mobile devices, such as vehicles or portable electronic appliances since, in this case, rapid and uncomplicated bridging of damaged individual cells, as is ensured by the present invention, is particularly important. The vehicles include, for example, land vehicles (such as passenger vehicles, cargo carrying vehicles, motor cycles, trains and the like), water craft and space craft.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A fuel cell comprising:
at least two bipolar plates;
a membrane electrode assembly, which is arranged between the bipolar plates and has at least one contact place with each bipolar plate, making indirect or direct electrical contact; and
a short-circuiting means provided in an area between or in the two bipolar plates, for short-circuiting the bipolar plates in response to the introduction of heat.

2. The fuel cell as claimed in claim 1, wherein:
the bipolar plates and the membrane electrode assembly have at least one common contact place; and
the short-circuiting means is provided in the area of the contact place for each respective bipolar plate.

3. The fuel cell as claimed in claim 1, wherein the short-circuiting means is arranged between at least one bipolar plate and the membrane electrode assembly.

4. The fuel cell as claimed in claim 1, wherein the short-circuiting means is one of:
integrated in the respective bipolar plates;
integrated in the membrane electrode assembly;
fitted to the bipolar plates; and
fitted to the membrane electrode assembly.

5. The fuel cell as claimed in claim 1, wherein the short-circuiting means is fusible and has a melting point between 50° C. and 120° C.

6. The fuel cell as claimed in claim 1, wherein the short-circuiting means is fusible and has a melting point between 80° C. and 90° C.

7. The fuel cell as claimed in claim 1, wherein at least one of the following is true:
each bipolar plate has a channel or pore structure to ensure that the melted short-circuiting means flows; and
the membrane electrode assembly has a channel or pore structure to ensure that the melted short-circuiting means flows.

8. The fuel cell as claimed in claim 1, wherein the short-circuiting means:
makes contact with both bipolar plates irrespective of the temperature;
is electrically conductive in a temperature range between 50° C. and 120° C.; and
is electrically isolating in other temperature ranges.

9. The fuel cell as claimed in claim 1, wherein the short-circuiting means:
makes contact with both bipolar plates irrespective of the temperature;
is electrically conductive in a temperature range between 80° C. and 90° C.; and
is electrically isolating in other temperature ranges.

10. The fuel cell as claimed in claim 1, wherein the membrane electrode assemble includes a polymer electrolyte membrane that can be melted through by means of the short-circuiting means.

11. The fuel cell as claimed in claim 1, wherein:
at least two fuel cells form a fuel cell stack, which is connected to a common gas inlet channel; and
the fuel cells or fuel cell parts which are arranged in an area of the gas inlet channel include the short-circuiting means.

12. The fuel cell as claimed in claim 11, wherein the fuel cells or fuel cell parts which are arranged in an area of the fuel cell stack where the temperature is critical have the short-circuiting means.
